(19) United States
(12) Patent Application Publication
(10) Pub. No.: US 2026/0340544 A1
(43) Pub. Date: Oct. 29, 2026

(54) SYSTEM FOR MONITORING AND OPTIMIZING DRYING OPERATIONS

(71) Applicant: GROWVERA, INC., Albuquerque, NM (US)

(72) Inventors: Brian Geoffrey Henderson, Albuquerque, NM (US); Jacob Bjorn Thordahl, Albuquerque, NM (US); Asher Paul May, Albuquerque, NM (US)

(21) Appl. No.: 19/110,779

(22) PCT Filed: Oct. 4, 2023
(86) PCT No.: PCT/US2023/075895

§ 371 Date: Mar. 11, 2025

Related U.S. Application Data
(60) Provisional application No. 63/413,110, filed on Oct. 4, 2022.

(51) Int. Cl. G06Q 10/0633; G05B 19/418

(52) U.S. Cl. CPC G06Q 10/0633; G05B 19/41835; G05B 2219/32043

(57) ABSTRACT

Disclosed are methods and systems for monitoring and optimizing plant drying operations comprising on-plant moisture sensors, environmental sensors, data analytics resource management server applications, and web-based and mobile software client applications. The present embodiments are directed to a turn-key solution for monitoring and optimizing plant drying operations. The core components that together make up the system are on-plant wireless battery-powered moisture sensors, cloud-based data analytics, algorithms, and resource management server applications, and web-based and mobile software client applications.

### CROSS REFERENCE TO RELATED PATENT APPLICATIONS

This patent application claims priority under 35 U.S.C. § 119(e) to, and the benefit of, U.S. provisional patent application 63/413,110 entitled “SYSTEM FOR MONITORING AND OPTIMIZING DRYING OPERATIONS”, which was filed on Oct. 4, 2022. U.S. Provisional Patent Application Ser. No. 63/413,110 is incorporated herein by reference in its entirety.

### TECHNICAL FIELD

Embodiments are generally related to systems and methods for monitoring and optimizing plant drying operations.

### BACKGROUND

Currently, there is a need for monitoring plant moisture content. Prior efforts have been unsuccessful or ineffective because they do not provide a comprehensive view into drying product moisture and ambient environmental conditions. In addition, prior approaches tend to be extremely time-consuming, cost-prohibitive, destructive to the plant, and/or do not include historical data. As such prior approaches provide no insights into drying operations in regard to drying chambers and plant characteristics. Likewise, prior approaches require an operator to be present to take measurements, and are often inconsistent or inaccurate since different anatomical portions of a plant can yield different moistures.

Still other prior approaches seek to non-destructively estimate the moisture content of plant material using indirect methods. These solutions fail to capture and account for the inherent variability of the drying process, can provide unreliable data due to inference of moisture from other measurements, and/or rely heavily on the uniformity and predictability of dry room conditions.

As such, a need exists for improved systems and methods for monitoring plant moisture and optimizing plant drying operations as detailed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide improved methods and systems for plant monitoring.

It is another aspect of the disclosed embodiments to provide a method, system, and apparatus for plant moisture content monitoring.

It is another aspect of the disclosed embodiments to provide a method, system, and apparatus for improved plant harvesting.

It is another aspect of the disclosed embodiments to provide a method, system, and apparatus for characterizing a drying process.

It is another aspect of the disclosed embodiments to provide a method, system, and apparatus for continuous data collection from multiple sources within a drying process, allowing for insights into drying chamber optimization, moisture optimization, and drying operations management.

In the embodiments herein, a system, method, and apparatus include a distributed sensing system with associated software that provides complete visibility into the drying process via direct on-plant moisture measurements and environmental monitoring. The system can comprise at least one sensor; and computer system, the computer system further comprising: at least one processor; a graphical user interface; and a computer-usable medium embodying computer program code, the computer-usable medium capable of communicating with the at least one processor, the computer program code comprising instructions executable by the at least one processor and configured for: inputting data from the at least one sensor; analyzing the data to characterize a drying process; and providing optimized drying condition output.

The present embodiments are directed to a turn-key solution for monitoring and optimizing plant drying operations. The core components that together make up the system are on-plant wireless battery-powered moisture sensors, cloud-based data analytics, algorithms, and resource management server applications, and web-based and mobile software client applications. The wireless sensors are installed on the drying plant material in the drying chamber and continuously transmit sensor data such as relative humidity, ambient temperature, and plant moisture to the cloud for storage and analytics. The cloud analytics compute distributed and aggregate statistics for room moisture and environmental conditions. These computed metrics are presented to the user via a web-based software application and can be used to monitor and optimize process control variables to reach target metrics such as final desired moisture, dry duration, wet-to-dry weight ratio, drying rate, and chemical profiles (e.g., terpene and flavonoid profiles). This information can also be used to proactively alert users of adverse conditions in their drying room and stop potential product losses. In addition, the analytics could be used to directly control environmental conditions in the drying chamber.

In an embodiment, a system comprises at least one sensor and a computer system, the computer system further comprising at least one processor and a computer-usable medium embodying computer program code, the computer-usable medium capable of communicating with the at least one processor, the computer program code comprising instructions executable by the at least one processor and comprising a server application configured for: collecting data from the at least one sensor attached to a plant; analyzing the data to characterize a drying process associated with the plant; and at least one client application configured for: providing the analyzed data associated with the drying process associated with the plant on a user interface. In an embodiment, the at least one sensor is capable of measuring at least one of moisture, temperature, and humidity. In an embodiment, analyzing the data to characterize the moisture content of the plant further comprises determining whether drying process conditions require intervention and sending an alert when the drying process conditions require intervention. In an embodiment, the server application is further configured for characterizing the spatial uniformity and quality of a drying chamber according to the data from the at least one sensor. In an embodiment, the client application is further configured for providing control commands to environmental hardware. In an embodiment, the environmental hardware comprises at least one of HVAC equipment, humidifiers, and dehumidifiers. In an embodiment, the system further comprises at least one off-plant sensor configured to measure at least one of humidity, temperature, pressure, light level, air flow, and water quality. In an embodiment, the server application is further configured for storing the data to characterize a drying process associated with the plant in a database organized according to the order of each drying process. In an embodiment, the server application is configured for generating predictive analytics during the drying process according to the analyzed data and historical data. In an embodiment, the predictive analytics comprise at least one of estimation of dry-process completion using data from previous dry processes, identification of adverse drying process conditions, recommended drying operational changes, and management and restriction of drying process operations. In an embodiment, the at least one sensor comprises a plurality of sensors wherein each sensor in the plurality of sensors is disposed on a different plant.

In an embodiment, a method for characterizing a drying process comprises connecting at least one sensor to a plant, collecting data from the at least one sensor at a server application, the server application being run on a computer system, the computer system further comprising: at least one processor; and a computer-usable medium embodying computer program code, the computer-usable medium capable of communicating with the at least one processor, the computer program code comprising instructions executable by the at least one processor and comprising: analyzing the data from the at least one sensor in order to characterize a drying process associated with the plant; and providing the analyzed data associated with the drying process associated with the plant with a client application. In an embodiment of the method, analyzing the data to characterize the moisture content of the plant further comprises determining whether drying process conditions require intervention and sending an alert when the drying process conditions require intervention. In an embodiment, the method further comprises characterizing the spatial uniformity and quality of a drying chamber according to the data from the at least one sensor. In an embodiment, the method further comprises providing control commands to environmental hardware in order to adjust ambient conditions associated with the drying process. In an embodiment, the method comprises measuring, with at least one sensor, at least one of moisture, temperature, and humidity. In an embodiment the method comprises measuring, with at least one off-plant sensor, at least one of humidity, temperature, pressure, light level, air flow, and water quality. In an embodiment, the method further comprises generating predictive analytics during the drying process according to the analyzed data and historical data. In an embodiment, the predictive analytics comprise at least one of estimation of dry-process completion using data from previous dry processes, identification of adverse drying process conditions, recommended drying operational changes, and management and restriction of drying process operations.

In another embodiment, a system comprises at least one sensor, a computer system, the computer system further comprising: at least one processor; and a computer-usable medium embodying computer program code, the computer-usable medium capable of communicating with the at least one processor, the computer program code comprising instructions executable by the at least one processor and comprising: a server application configured for: collecting data from the at least one sensor attached to a plant; analyzing the data to characterize a drying process associated with the plant; sending an alert when conditions associated with the drying process require intervention; and controlling environmental hardware in the environment associated with the drying process; a second computer system, the second computer system further comprising: at least one processor; a graphical user interface; and a computer-usable medium embodying computer program code, the computer-usable medium capable of communicating with the at least one processor, the computer program code comprising instructions executable by the at least one processor and comprising: at least one client application configured for: providing the analyzed data associated with the drying process associated with the plant on a user interface. In an embodiment, the at least one sensor comprises an upper housing, a printed circuit board housed in the upper housing, a lower housing, an axel pin connecting the upper housing and lower housing, and at least one probe configured to be inserted into a plant. In an embodiment, the printed circuit board further comprises a probe subsystem, a power and battery management subsystem, a processing subsystem, a user interface subsystem, a radio subsystem, and an analog front end subsystem.

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1A depicts a block diagram of a system for dryness control and monitoring, in accordance with the disclosed embodiments;

FIG. 1B depicts a block diagram of another embodiment of a system for dryness control and monitoring, in accordance with the disclosed embodiments;

FIG. 2 depicts a method of monitoring an environment, in accordance with the disclosed embodiments;

FIG. 3A depicts a plant moisture sensor, in accordance with the disclosed embodiments;

FIG. 3B depicts another view of a plant moisture sensor, in accordance with the disclosed embodiments;

FIG. 3C depicts another view of a plant moisture sensor, in accordance with the disclosed embodiments;

FIG. 4 depicts another embodiment of a plant moisture sensor, in accordance with the disclosed embodiments;

FIG. 5A depicts another embodiment of a plant moisture sensor, in accordance with the disclosed embodiments;

FIG. 5B depicts a separated view of a plant moisture sensor, in accordance with the disclosed embodiments;

FIG. 5C depicts a printed circuit board, in accordance with the disclosed embodiments;

FIG. 5D depicts a printed circuit board, in accordance with the disclosed embodiments;

FIG. 5E depicts a printed circuit board, in accordance with the disclosed embodiments;

FIG. 6A depicts another embodiment of a plant moisture sensor, in accordance with the disclosed embodiments;

FIG. 6B depicts a separated view of a plant moisture sensor, in accordance with the disclosed embodiments;

FIG. 6C depicts a printed circuit board, in accordance with the disclosed embodiments;

FIG. 6D depicts a printed circuit board, in accordance with the disclosed embodiments;

FIG. 6E depicts a printed circuit board, in accordance with the disclosed embodiments;

FIG. 7 depicts a block diagram of exemplary circuit components, in accordance with the disclosed embodiments;

FIG. 8 depicts a block diagram illustrating aspects of a server application, in accordance with the disclosed embodiments;

FIG. 9 depicts a block diagram illustrating aspects of a client application, in accordance with the disclosed embodiments;

FIG. 10A depicts an exemplary screen view associated with a graphical user interface of a client application, in accordance with the disclosed embodiments;

FIG. 10B depicts another exemplary screen view associated with a graphical user interface of a client application, in accordance with the disclosed embodiments;

FIG. 10C depicts another exemplary screen view associated with a graphical user interface of a client application, in accordance with the disclosed embodiments;

FIG. 10D depicts another exemplary screen view associated with a graphical user interface of a client application, in accordance with the disclosed embodiments;

FIG. 10E depicts another exemplary screen view associated with a graphical user interface of a client application, in accordance with the disclosed embodiments;

FIG. 10F depicts another exemplary screen view associated with a graphical user interface of a client application, in accordance with the disclosed embodiments;

FIG. 10G depicts another exemplary screen view associated with a graphical user interface of a client application, in accordance with the disclosed embodiments;

FIG. 10H depicts another exemplary screen view associated with a graphical user interface of a client application, in accordance with the disclosed embodiments;

FIG. 10I depicts another exemplary screen view associated with a graphical user interface of a client application, in accordance with the disclosed embodiments;

FIG. 10J depicts another exemplary screen view associated with a graphical user interface of a client application, in accordance with the disclosed embodiments;

FIG. 10K depicts another exemplary screen view associated with a graphical user interface of a client application, in accordance with the disclosed embodiments;

FIG. 10L depicts another exemplary screen view associated with a graphical user interface of a client application, in accordance with the disclosed embodiments;

FIG. 10M depicts another exemplary screen view associated with a graphical user interface of a client application, in accordance with the disclosed embodiments;

FIG. 10N depicts another exemplary screen view associated with a graphical user interface of a client application, in accordance with the disclosed embodiments;

FIG. 10O depicts another exemplary screen view associated with a graphical user interface of a client application, in accordance with the disclosed embodiments;

FIG. 10P depicts another exemplary screen view associated with a graphical user interface of a client application, in accordance with the disclosed embodiments;

FIG. 11 depicts an exemplary chart, in accordance with the disclosed embodiments;

FIG. 12 depicts a block diagram of a computer system which is implemented in accordance with the disclosed embodiments;

FIG. 13 depicts a graphical representation of a network of data-processing devices in which aspects of the present embodiments may be implemented; and

FIG. 14 depicts a computer software system for directing the operation of the data-processing system depicted in FIG. 12, in accordance with an example embodiment.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter, with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope and concept of the invention as defined by the appended claims.

Embodiments disclosed herein are directed to a distributed sensing system with associated software that provides complete visibility into the drying process via direct on-plant moisture measurements and/or environmental monitoring. By way of example, certain crops require drying before they can be harvested, packaged, and shipped for wholesale or retail distribution. There are numerous examples of crops that require such treatment.

For products that are sold by weight there is a delicate balance between allowing the plant to dry sufficiently for production, and allowing the plant to become over dry, at which point it is weight decrease and it becomes less valuable. The embodiments disclosed herein provide a complete picture of the actual dryness of the plants and associated drying environment. This allows for the efficient drying of the product, as well as harvesting at the optimal point of dryness to maximize both efficiency and profit.

The present embodiments are directed to systems and methods for monitoring and optimizing plant drying operations. The system includes on-plant wired or wireless battery-powered moisture sensors, cloud-based data analytics, resource management server applications, and web-based and mobile software client applications. The wireless sensors can be installed on the drying plant material and can then continuously transmit sensor data such as relative humidity, ambient temperature, vapor-pressure deficient, and plant moisture to the cloud for storage and analytics. The cloud analytics compute distributed and aggregate statistics for room moisture and environmental conditions. These computed metrics can be provided to the user via a web-based software application and can be used to monitor and optimize process control variables to reach target metrics such as final desired moisture, dry duration, wet-to-dry weight ratio, drying rate, and terpene profiles. This information can also be used to proactively alert users of adverse conditions in the drying environment, in order to prevent or mitigate potential product losses. In addition, the analytics can be used to directly control environmental conditions in the drying environment.

In certain embodiments analytics can also be used to compute water activity based on moisture measurements remotely or locally.

One aspect of the disclosed embodiments is a sensor architecture that is capable of measuring plant moisture in a non-destructive manner. The sensor measures plant moisture using Electrical Impedance Spectroscopy (EIS). Aspects include a system and software capable of providing real-time actionable insights via data analytics on aggregated moisture and environmental data. The aforementioned real-time actionable insights can include dynamic alerting of adverse and critical dry room events stemming from collective or individually sensed moisture or environmental conditions. Aspects further include a system and software where the aforementioned insights are presented via a web-based or app-based framework as a turnkey solution. Still further, the aforementioned real-time actionable insights can be stored and optionally combined with other data sources to perform historical analytics which can be used to inform future operational decision making.

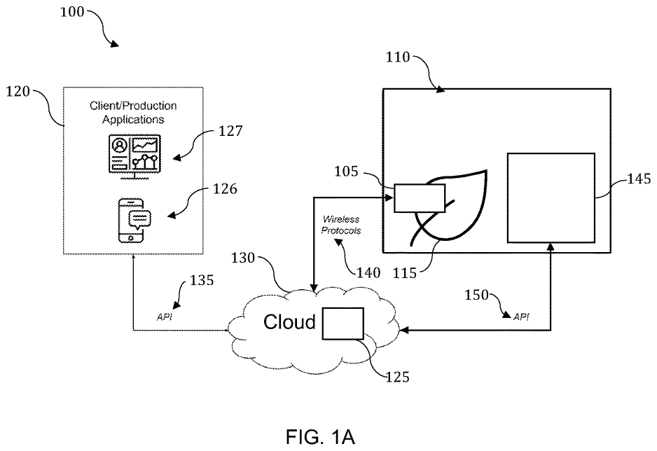

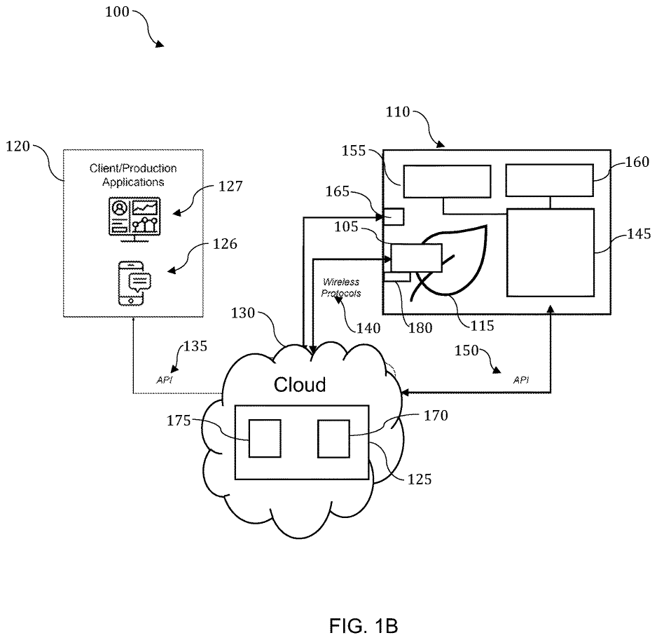

FIG. 1 illustrates aspects of a system 100 comprising hardware and associated computer processes which can be implemented with software, in accordance with the disclosed embodiments. The system 100, can include wireless (or optionally wired) on-plant moisture and environmental sensor 105 disposed in an environment 110. In certain embodiments, the sensor 105 can measure conditions associated with plant matter including but not limited to moisture content of plant matter and temperature of the plant matter. In addition, the sensor 105 can measure certain environmental conditions, including but not limited to, ambient temperature, humidity, barometric pressure, light intensity, and light type. It should be understood that multiple sensors can be used in the environment 110, and that the single sensor 105 illustrated in FIG. 1 is shown for simplicity. In certain embodiments, a plurality of sensors 105 can be used with each sensor in the plurality of sensors engaged on a different plant.

In certain embodiments the environment 110 can comprise a drying facility, although in other embodiments, the environment can more generally be any environment where plants are grown or processed. The sensor 105 can be configured to be operably affixed to a plant 115, in the environment as further detailed herein.

The system 100 further includes client application 120, and a server application 125. In certain embodiments one or both of these applications can be provided as a cloud 130 application.

These components can be connected with bi-directional or uni-directional wireless communication that connects sensors 105 to the server application 125. The client application 120 can communicate with the server application 125 via an application programming interface (API) 135.

In operation, the sensors 105 report data and manage configuration via wireless protocols 140 to the cloud 130 from the environment 110. Control systems 145 and client applications 125 communicate with the cloud 130 via an API 150.

It should be appreciated that the client application 125 can comprise a downloadable software application or “app” 126, or can comprise a software application 127 running on a computer system. It is possible for the client application 125 to be distributed on multiple devices to allow various users to access the client application. In certain embodiments, the client applications are used to monitor sensor 105 data, and alter environmental conditions in the environment 110 via the control systems 145 as further detailed herein.

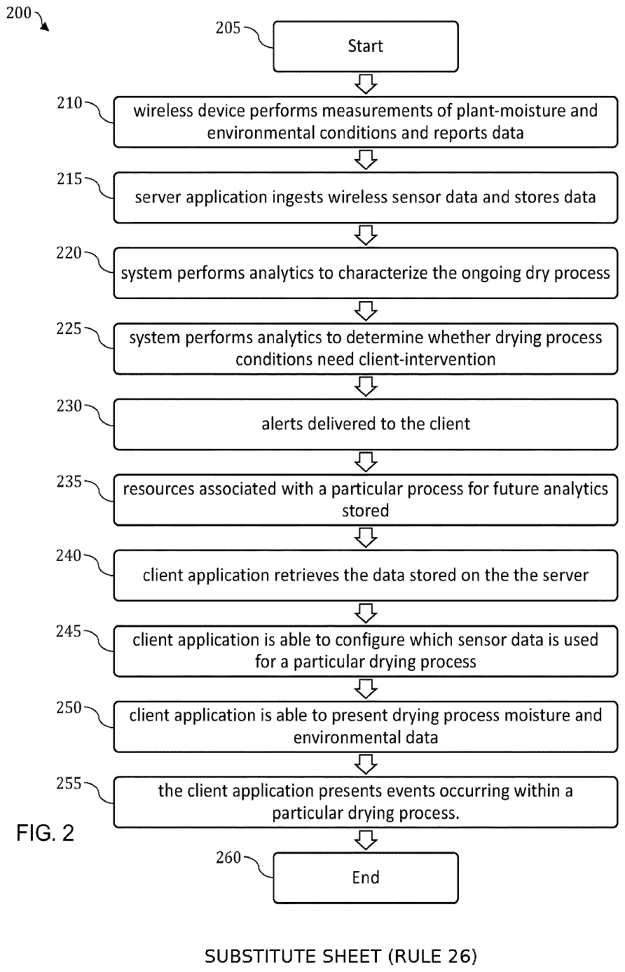

FIG. 2 illustrates an associated method 200 for monitoring plant moisture, which can be implemented with the system described in FIG. 1. The method starts at block 205.

As illustrated at block 210, the sensor 105 performs a measurement of plant-moisture and environmental conditions and reports data to the server application 125 via a wireless protocol 140. Plant moisture and/or environmental conditions can be measured via impedance spectroscopy and/or via temperature and humidity sensors. Data collection from the sensor 105 can be continuous or periodic. Likewise, data transmission to the server application 125 can be pushed to the server application 125 continuously for near real-time monitoring; can be pushed to the server application 125 periodically based on a pre-set time interval, or can be pulled to the server application 125, either at a pre-set time interval, or on demand based on a data pull request from the client application 120.

At step 215, the server application 125 ingests the wireless sensor 105 data and stores that data in a data storage structure. In certain embodiments, the data storage structure can be secured. The server application 125 performs analytics at step 220 to characterize the ongoing dry process for data presentation via the client application 120. The analytics may comprise statistical analyses, machine learning algorithms used to evaluate data, or artificial intelligence algorithms used to analyze current and/or historical dry process datasets, and other such analytics.

The system can continuously characterize the drying process by gathering real-time data on temperature, humidity, and plant moisture levels across various drying plants. The system can likewise collect data from the environment to characterize the environment. These collected data points serve as the basic data for estimating additional critical parameters including water activity, vapor pressure deficit (VPD), and water potential, all of which play significant roles in optimizing the drying process. A comprehensive characterization of the drying process is attained through an intricate spatiotemporal analysis of these parameters, in conjunction with supplementary metadata including but not limited to, the duration of the drying process, and the specific time of the year in which it occurs.

The characterization of the drying process can be presented as heatmaps of spatiotemporal variation of any of the aforementioned parameters within a particular drying process or environment, recommendations on optimal drying strategies for different plant types based on temporal analysis of any of the aforementioned parameters, and predictive dates of completion based on current data.

The server application 125 performs analytics to determine whether drying process conditions require intervention at step 225. Intervention may be required where conditions aberrate from expected conditions, or when certain pre-set thresholds are exceeded. For example, anomalous or unexpected drying conditions may require intervention. If the humidity level measure by the sensor 105 in the environment 110, drops below a floor threshold or rises above a ceiling threshold, the server application 125 analytics will recognize the condition. Anomalous drying conditions may also include environmental conditions, moisture measurements outside of desired ranges, or unexpected levels of variability, or the like. Anomalous conditions may be determined using historical data, or can be specified at thresholds at the client application 120.

At step 230, the server application 125 can deliver alerts to the client application 120 should anomalous conditions arise. The alerts can be provided via the client application 120, via SMS messages to one or more preset receivers, via push notifications, via email, or with other such notification methods. In certain embodiments, the alert can include color coded indexing depending on the severity of the anomaly. Repeated alerts can be provided if the anomalous condition is not rectified.

The server application 120 is capable of storing all collected data associated with a particular process, as illustrated at block 235, for future analytics. Such data can include the sensors used, data collected during the drying process, and any other such metadata. This data, which may be optionally combined with other data sets, may be used to analyze long term trends to inform future operations. For example, the long term trends can be provided to trained machine learning algorithms which can be used to analyze long term trends to model expected future outcomes.

The server application 125 can also provide a configurable interface to access the resources presented by the system 100 via an API. At step 240, the client application 120 retrieves the data stored on the server application 125 via the API 135. The client application 120 can create, initiate, and terminate a data collection process via the API 135. The client application 120 can be used to configure the sensors 105 in the environment as shown at block 245. For example, the client application can configure one or more sensors 105 to monitor specific metrics, collect samples continuously or at intervals, select certain sensors for certain measurements, select sensor data that is used for a particular drying processes, and the like, via the API 135.

As shown at step 250, the client application 120 is also able to present ongoing or completed drying process moisture and environmental data via an associated user interface. At step 255 the client application 120 can also present events occurring within a particular drying process via an associated user interface. The method ends at 260. It should be appreciated that the order of steps in method 200 is meant to be exemplary. In other embodiments, certain steps or processes may be completed in a different order without departing from the scope of embodiments provided herein.

In further embodiments, the system 100 can include additional aspects as illustrated in FIG. 1B. Identical or similar features are consistently labeled with matching reference numerals in FIGS. 1A and 1B. As illustrated in FIG. 1B, an exemplary embodiment of the system 100 for monitoring and optimizing plant drying operations is illustrated. In the exemplary embodiment, the system 100 can include wired and/or wireless sensors 105 on plant, as well as off-plant sensors 165. In combination sensors 105 and sensors 165 can be used to measure plant moisture, ambient environment, environmental control system state through vendor provided interfaces, and lighting conditions. In certain embodiments, the sensors 105 and/or sensors 165 can include plant moisture sensors, humidity sensors, temperature sensors, light sensors, air flow sensors, water quality sensors, soil sensors, imaging sensors, or the like. As illustrated in FIG. 1B sensors 105 and/or sensors 165 can be integrated with plant drying racks 180, trays, or other such equipment. The system 100 can further include control system 145 configured to control environmental hardware 160 including but not limited to, HVAC equipment, humidifiers, and dehumidifiers, according to data collected by the sensors in current dry processes and/or historical data sets. The system 100 can include dedicated dry process control and monitoring consoles 155 for use onsite or at a user facility. Monitoring consoles can provide similar functionality to the client application 120.

The embodiments can include a system 100 can further integrate with external dry-process affecting systems (e.g., HVAC and environment control 160), optimization of plant cure and storage activities, optimization of plant growing activities, and optimization of rooting and cloning activities. In certain embodiments such integration can be realized through third-party system APIs.

In other embodiments, the system 100 can include a dedicated resource management system 170, for server-side comparative analytics on completed dry processes to determine current and historical performance metrics of environments (such as dry chambers, drying facilities, and the like), plant types, or any other collected data associated with a dry-process.

Additional aspects can include server-side predictive analytics 175 for ongoing processes to provide any of, but not limited to, the following: estimation of dry-process completion using data from previous dry processes, detection of adverse drying process conditions, recommendations of operational changes; tenant management systems (server-side or external) that enable management and restriction of drying process operations, dry process resources, and drying analytics as they would be managed at customer organizations; API for integration with third-parties, e.g. control systems for HVAC; metadata regarding, but not limited to, plant grow-cycle information, post-process information, final sale information; and audit trail for asset tracking and regulatory compliance.

One aspect of the embodiments is the use of one or more wired or wireless on-plant moisture sensors 105 that can be distributed throughout an environment 110 on the plants 115. One or more plant moisture sensors 105 can be distributed across one or more plants 115 in the dry space 110. Other embodiments of sensors 105 can also be configured to measure both plant moisture, and other environmental metrics such as temperature and humidity. The system architecture can support an arbitrarily large number of sensors 105, and sensors 165, to address the needs of all scales of operations. In certain embodiments, the system 100 can include a facility-wide wireless sensor network including multiple sensors 105 and sensors 165, and other external sensors for supporting data collection throughout the production lifecycle.

Similarly, the associated software incorporates time series data associated with all dry operations recorded with the system 100, which is stored in the cloud 125. Analytics data and results around dry operations optimization, e.g., optimal HVAC settings, and comparative analytics results on dry operation performance are possible. Operations and data are centrally managed in the cloud 130 and accessible by client applications 120 at any location.

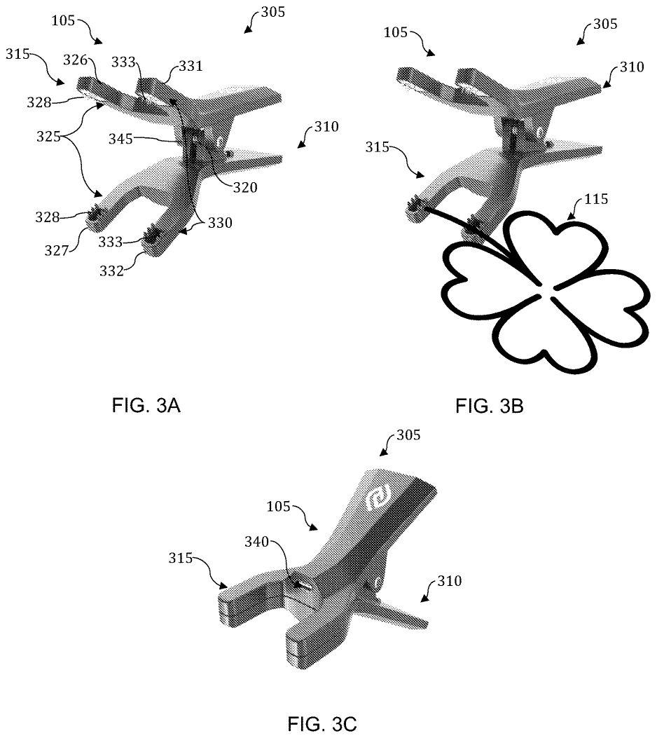

In certain embodiments, the sensors 105 can include an on plant moisture sensor as illustrated in FIGS. 3A-3C. For example, in an embodiment, the on plant moisture sensor 105 can comprise an alligator clip 305, comprising a handle side 310 and a set of jaws 315 with a hinge 345 and spring 320 configured to bias the jaws 315 shut. The jaws 315 can include two sets of fingers, first side fingers 325 and second side fingers 330. The first side fingers 325 include an upper finger 326 and a bottom finger 327, both of which are fitted with probes 328. Likewise, the second side fingers 330 include an upper finger 331 and a bottom finger 332, both of which are fitted with probes 333.

The probes 328 and probes 333 can be operably connected to a wired connection or dongle so that power and/or data can be provided to and from the sensor 105. A port 340 can be provided to make the wired connection. Alternatively, the housing 335 of the sensor 105 can be configured with a wireless transceiver and power supply allowing the sensor to operate without a wired connection. The power supply (e.g., battery) can be charged via port 340.

FIG. 3A illustrates the sensor 105 with jaws 315 open. FIG. 3B illustrates the sensor 105 with jaws 315 open and a plant 115 inserted against probes 328 and probes 333. FIG. 3C illustrates the sensor 105 with jaws 315 closed.

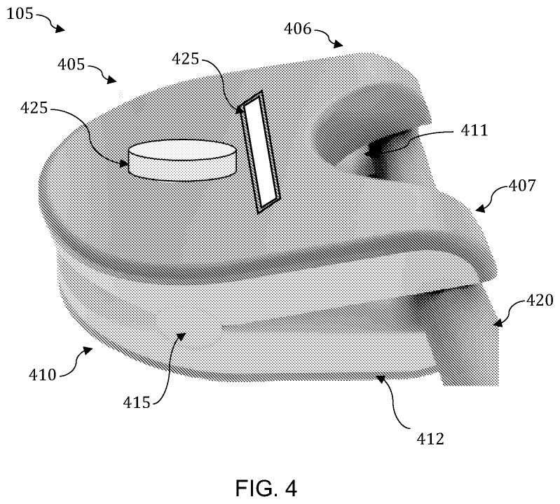

FIG. 4 illustrates another embodiment of a sensor 105. In this embodiment, an upper housing 405 and lower housing 410 are joined with a pin 415 which can include a spring (not shown) to bias the upper housing 405 and lower 410 toward one another. The upper housing 405 has two fingers, finger 406 and finger 407, with probes (not shown) formed on each of the fingers 406 and 407. Likewise, the lower housing 410 has two fingers, finger 411 and finger 412, with probes (not shown) formed on each of the fingers 411 and 412. The fingers are configured to push the probes into part of a plant, such as a plant stock 420, as illustrated in FIG. 4. It should be appreciated that the probes can be inserted in other parts of a plant as well.

In this embodiment, the sensor 105 can comprise a standalone on-plant sensor with local on-device display 425 of moisture. No wireless connectivity is required. A button 430 can be provided on the housing. Operating the button takes a sensor reading and a representation of the moisture can be provided via LEDs, numerical display 425, audible feedback, or other such indication method.

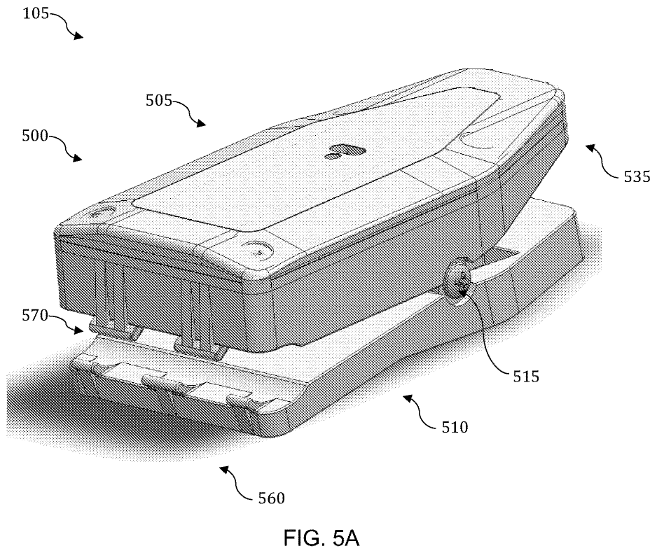

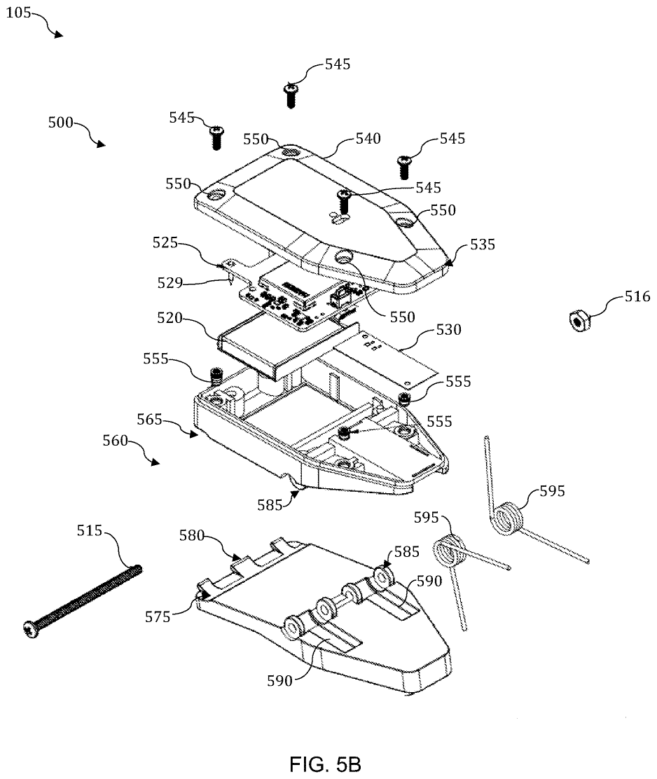

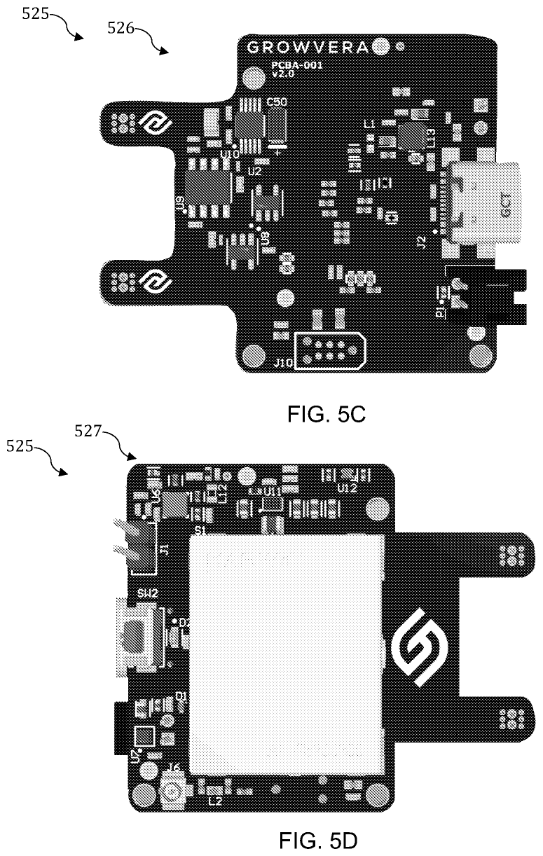

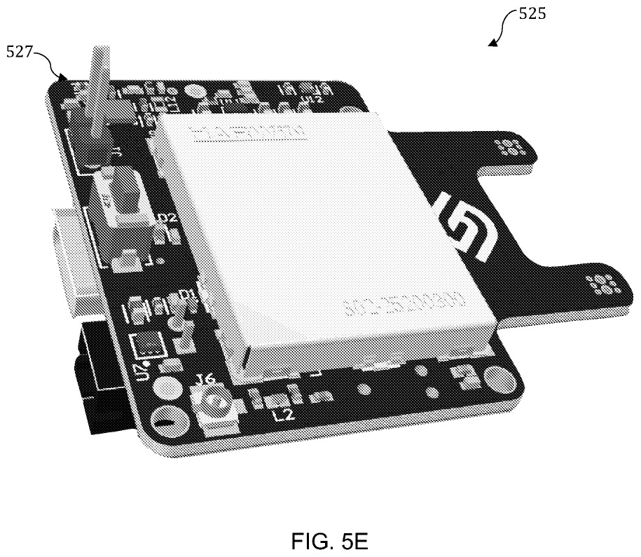

FIG. 5A and FIG. 5B illustrate aspects of another embodiment of a plant sensor 105 in accordance with the disclosed embodiments. In this embodiment, the sensor 105 includes a housing 500 comprising an upper housing 505 and a lower housing 510 connected with an axel pin 515. The upper housing 505 and lower housing 510 are configured to hold printed circuit boards as further detailed herein, and when joined form a tray with probes therein to engage a plant part.

FIG. 5B provides a separated view of the sensor 105, where additional aspects of the sensor are made clear. As illustrated, the upper housing 505 is configured to house a mounting plate 520 configured to hold first PCB 525. As illustrated, the first PCB 525 is operably connected to probes 529 which can extend out of the upper housing 505 to engage a plant part. A second PCB 530 can be housed in the tail side 535 of the housing 505. The upper housing 505 is further enclosed with cover 540 which can be secured with mounting screws 545 configured to extend through mounting holes 550 and engage threaded slots 555.

The nose end 560 of the upper housing 505 includes a half tray 565 with associated teeth 570. The lower housing 510 has a similar half tray 575 with teeth 580. The teeth 580 in the lower half tray 575 and teeth 570 in the upper half tray are spaced to fit between one another when the upper housing and lower housing are pushed together, forming a full, in some cases tubular, tray to engage a plant part.

The lower housing 510 further includes lower axel pin mounting rings 585. The upper housing 505 similarly includes upper axel pin mounting rings, configured in spaced relation to the lower axel pin mounting rings 585 so that the axel pin 515 can be inserted through the upper and lower axel pin mounting rings 585 to join the upper housing 505 and lower housing 510, and secured with nut 516.

The upper housing 505 and lower housing 510 can include one or more spring slots 590 configured to hold one or more spring 595. The springs bias the tail side 535 of the upper housing 505 and lower housing 510 away from each other, and simultaneously bias the nose end 560 of the upper housing and lower housing 510 toward one another so that the nose end clamps around a plant part in the tray.

FIGS. 5C-5E illustrate exemplary aspects of the printed circuit board 525. The printed circuit board 525 can be used to realize various aspects of the systems and methods disclosed herein. FIG. 5C illustrates a first side 526 of the PCB 525. FIG. 5D illustrates a second side 527 of PCB 525. FIG. 5E illustrates a perspective view of the PCB 525.

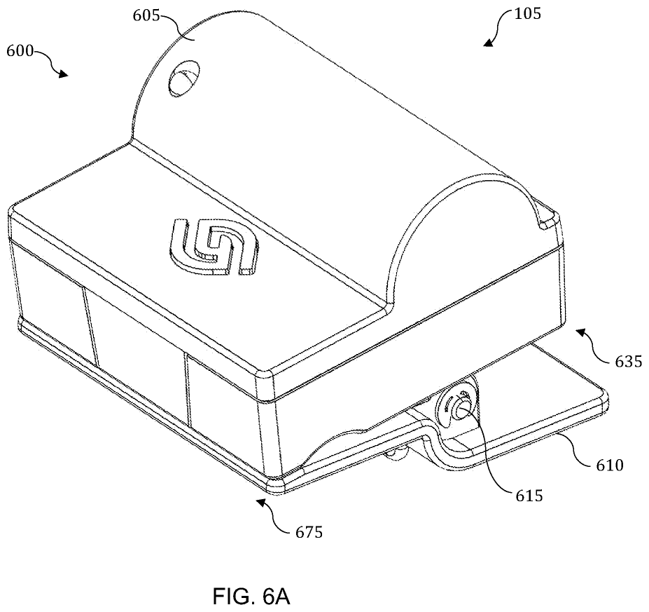

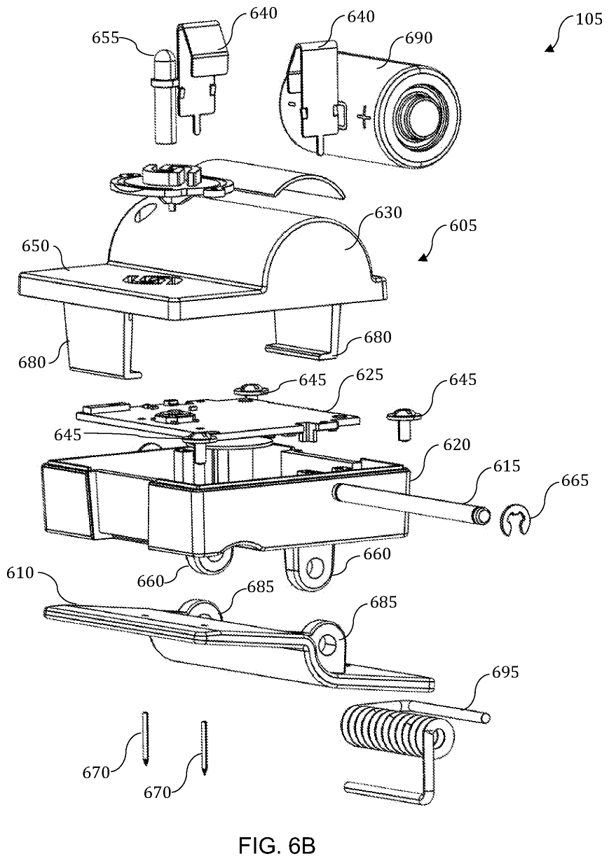

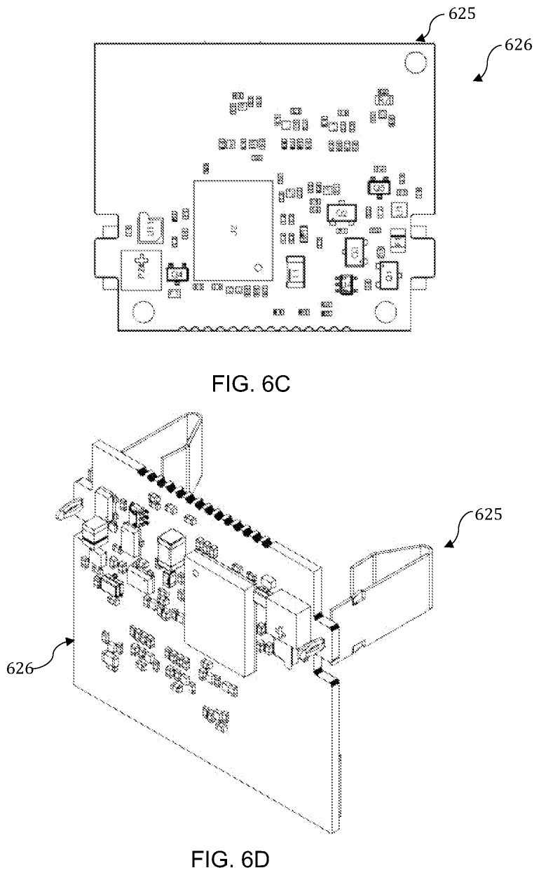

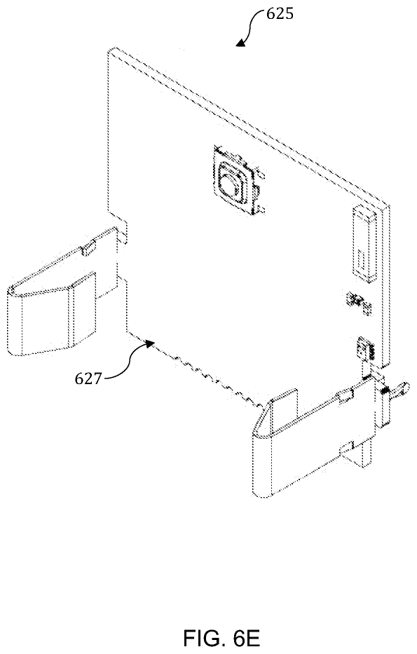

FIG. 6A and FIG. 6B illustrate aspects of another embodiment of a plant sensor 105 in accordance with the disclosed embodiments. In this embodiment, the sensor 105 includes a housing 600 comprising an upper housing 605 and a lower clip 610 connected with an axel pin 615. The upper housing 605 and lower clip 610 are configured to hold a printed circuit board as further detailed herein, and when joined form a clamp with probes 670 therein to engage a plant part.

FIG. 6B provides a separated view of the sensor 105, where additional aspects of the sensor are made clear. As illustrated, the upper housing 605 is configured to house a mounting tray 620 configured to hold a PCB 625. As illustrated, the PCB 625 is operably connected to probes which can extend out of the upper housing 605 to engage a plant part. The tail side 635 of the housing 605 includes a battery compartment 630 for a battery 690. The upper housing 605 is further configured with power leads 640 which can be connected to the PCB 625 to provide power. Mounting screws 645 configured to extend through top cover 650 to secure the top cover to the upper housing 605. An LED indicator light 655 is operably connected to the PCB 625 and extends out top cover 650. The top cover further includes wing snaps 680.

The lower clip 610 further includes lower axel pin mounting rings 685. The upper housing 605 similarly includes upper axel pin mounting rings 660, configured in spaced relation to the lower axel pin mounting rings 685 so that the axel pin 615 can be inserted through the upper and lower axel pin mounting rings 685 to join the upper housing 605 and lower clip 610, and secured with clip stop 665.

The upper housing 605 and lower housing 610 can be operably engaged to spring 695. The spring 695 biases the tail side 635 of the upper housing 605 and lower clip 610 away from each other, and simultaneously biases the nose end 675 of the upper housing 605 and lower clip 610 toward one another.

FIGS. 6C-6E illustrate exemplary aspects of the printed circuit board 625. The printed circuit board 625 can be used to realize various aspects of the systems and methods disclosed herein. FIG. 6C illustrates a first side 626 of the PCB 625. FIG. 5D illustrates a perspective view of PCB 625. FIG. 5E illustrates a second side 627 the PCB 625.

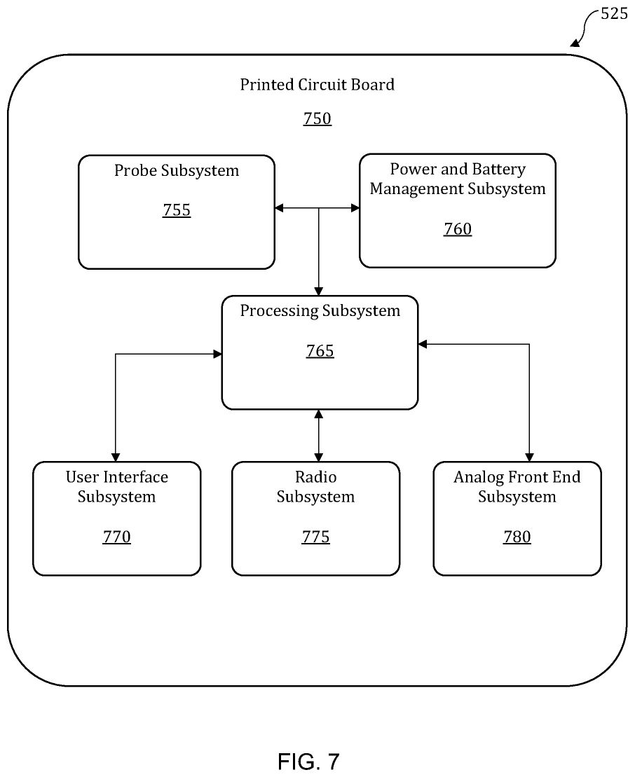

FIG. 7 is a block diagram illustrating functional aspects of the printed circuit board 525 associated with sensor 105. The printed circuit board 525 includes the board itself 750 along with a number of circuit elements, illustrated as subsystems in FIG. 7D. The circuit elements generally include a probe subsystem 755 operably connected to a power and battery management subsystem 760. Both the probe subsystem and power and battery management subsystem are further connected to the processing subsystem 765. A user interface subsystem 770 is provided in operable communication with the processing subsystem 765. Likewise, a radio subsystem 775 and analog front end subsystem 780 are operably connected to the processing subsystem 765. Aspects of each of these subsystems are further detailed here.

The sensor 105 collects data to measure plant moisture using Electrical Impedance Spectroscopy (EIS). The analog front end subsystem 780 generates a sinusoidal stimulus voltage with a known magnitude, phase, and frequency which is applied to the plant through a drive amplifier via probe subsystem 755. The dynamic current response of the plant tissue in response to the stimulus voltage is converted to a voltage by a transimpedance amplifier (TIA). The output of the TIA is then digitized and processed using Fourier analysis techniques into its real and imaginary components. Frequencies of interest are then processed to obtain a plant moisture measurement using a previously determined calibration profile.

The processing subsystem 765 is the heart of the PCB 525. The processing subsystem is responsible for signal generation and signal capture. The processing subsystem 765 can include a data processor for data processing, and serves as the system manager for all the other subsystems, all of which are connected to the processing subsystem 765.

Another aspect is the power and battery management subsystem 760. The power and battery management subsystem includes circuit components for powering the other subsystems with a rechargeable or primary battery. Additionally, the power and battery management subsystem provides battery power management, low power mode management, controls battery charging as required, battery discharging, and provides battery status management updates to the processing subsystem 765.

The PCB 525 further includes an analog front end subsystem 780. The analog front end subsystem is responsible for the arbitrary waveform generation necessary for moisture detection via the probe subsystem 755. Likewise, the analog front end subsystem 780 provides waveform amplification, configurable signal conditioning, and analog waveform digitization.

The probe subsystem 755 serves as the interface between the PCB and plant material. Probes associated with the probe subsystem 755 can be inserted into plant material.

The PCB 525 also includes a wireless or radio subsystem 775. The radio subsystem 775 provides communication with the server application 120 for data reporting and system configuration. The radio subsystem can include dedicated hardware tailored to wireless protocol.

Finally, the user interface subsystem can comprise at least one multi-function button for providing user input, and at least one multi-function LED indicator for indicating, for example, probe operation, testing status, and/or battery life. In other embodiments, light sensors, temperature sensors, pressure sensors, and humidity sensors can also be included in the sensor.

The PCB 525 serves as the component used to measure moisture content of the plant. In certain embodiments, the probes associated with the probe subsystem 755 are inserted into the plant probe readings can be processed by the PCB 525 to determine the moisture content in the plant. In other embodiments, the plant flower material can also be measured directly using the sensor 105.

Aspects of the disclosed embodiments further include software applications configured to operate in combination with the hardware disclosed herein to provide complete visibility into the drying process via direct on-plant moisture measurements and environmental monitoring.

In certain embodiments, software applications can be configured to command and control external systems associated with the environment 110 including, but not limited to, HVAC, lighting, and other environmental and physical systems. For example, the temperature, humidity, and light associated with an environment 110 can be operably connected to the system 100 via wired or wireless communication. As data is collected, the system 100 can identify potential changes to the environment to optimize drying conditions. The system 100 can optionally, automatically adjust the temperature and humidity via the local HVAC system, and light controls in the environment 110, or can provide notices suggesting changes to optimize the conditions, which can then be carried out by an operator. This can include real-time reporting of the current state of the plant matter and room conditions and real-time alerting as to adverse or expected conditions within the dry space. For example, users may receive SMS alerts or email alerts when the temperature of a drying space falls outside the expected range.

In an exemplary embodiment, the server application 125 can include a comparison module configured to provide a comparison of current dry space state and plant conditions with historical data. This can include measurements and variability of plant moisture, temperature, humidity, yield history, and complete dry duration. The data can be used for predictive decision making and control of dry space.

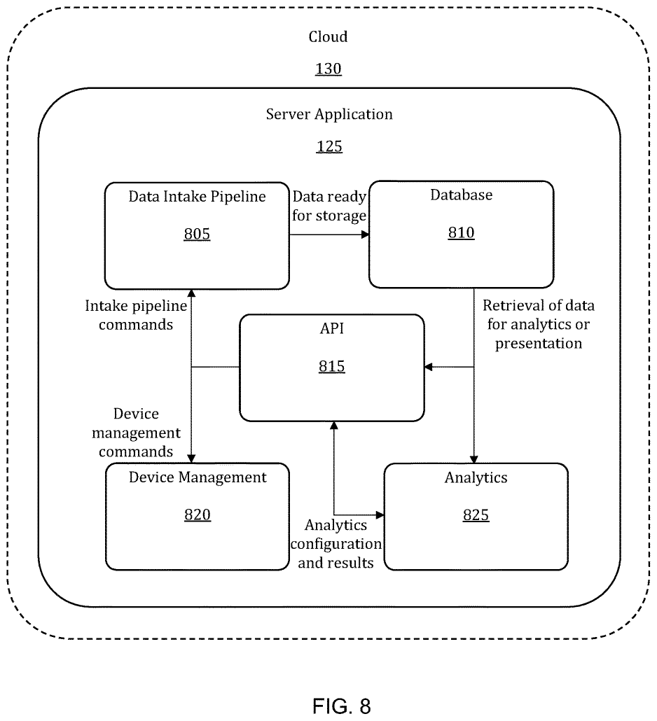

As previously described, the system 100 can include a cloud 130 based server application 125. Aspects of the server application 125 are illustrated as a block diagram in FIG. 8. One aspect of the server application 125 is to collect and store data from the plant 115 and/or dry space environment 110 to be used in current and future operations. The server application 125 can generally include a data intake pipeline 805, data storage structure (e.g., a database) 810, an API 815, a device manage module 820, and an analytics engine 825. Aspects of these modules are further detailed herein.

The server application 125 can include an API 815 which provides the interface to a mobile, web, or production application (e.g., client application 120) for managing, viewing, configuring, and analyzing data collected by, or provided to, system 100. The API 815 can also be used to provide anonymous data to 3^{rd} party research institutions or integrate with customer information systems. The API 815 can be operably connected and to the data intake pipeline 805 and device management module 820. The API can further receive input from the database 810, and is operably connected to the analytics engine 825.

The data intake pipeline 805, is used to collect, filter, and sort incoming data, for example, from the sensor 105, or from another external data source. Once the data is ready for storage. It can be stored in long term durable data storage embodied in FIG. 8 as a database 810. The data is available from the database 810 on-demand and may be organized according to the order of each drying process.

The server application 815 also includes device management module 820, which comprises a dedicated infrastructure tailored to wireless device protocol. The device management module 820 further provides management of device security and state.

The Analytics engine 825 can generate predictive analytics during drying processes by reference to historical data or using artificial intelligence based inference. As such, the Analytics engine 825 can comprise a trained machine learning algorithm, or other such analytics tool, and has access to the data in the database 810. After the drying process is complete the analytics engine 825 can generate comparative and performance analytics by referencing saved datasets. In certain embodiments the analytics engine can employ different strategies to effectively measure plants according to the species and genetics of the plants. The analytics engine can also be used to characterize the performance of a given environment 110, such as a drying room performance.

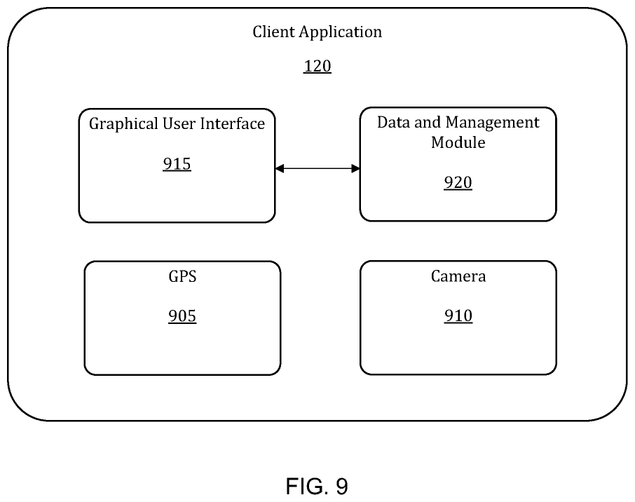

FIG. 9 provides a block diagram of aspects of the client application 120. The client application 120 serves as the medium through which a user configures and controls the system 100. The client application can comprise downloaded software running on a mobile device, cell phone, computer, or other such computer device. In some embodiments the client application 120 can be a web portal. The client application serves as the interface through which the user interacts with the system 100. The client application can be operably connected to a camera 905, and GPS receiver 910, such that the device can verify position and time.

The client application 120 can further include a specially designed graphical user interface 915 that allows the user to receive data including data collected by the sensors, scheduling, alerts, and the like. The client application can interact with other aspects of the system 100, such as the server application 125 through a wired or wireless connection via the world wide web. In certain embodiments, this can be achieved using a cloud 130 computing architecture.

The client application can further include a data and management module 920 which can be configured to control, and display current conditions and predicted outcomes in the dry space. The client application 120 can also display analysis and historical trends of dry space and strain performance and provide local resource monitoring of all sensors and systems associated with the dry space. The GUI 915 can be used to control sensor function, and in certain embodiments, to modify hardware components in the environment, including but not limited to, HVAC systems, watering systems, humidity control systems, and the like.

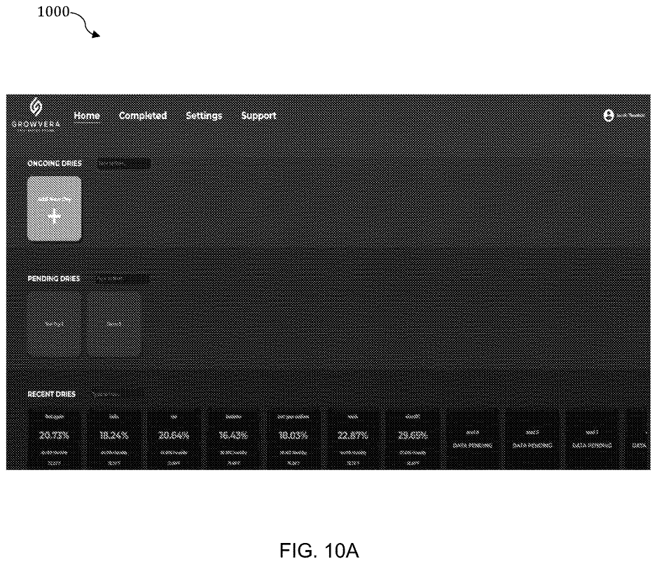

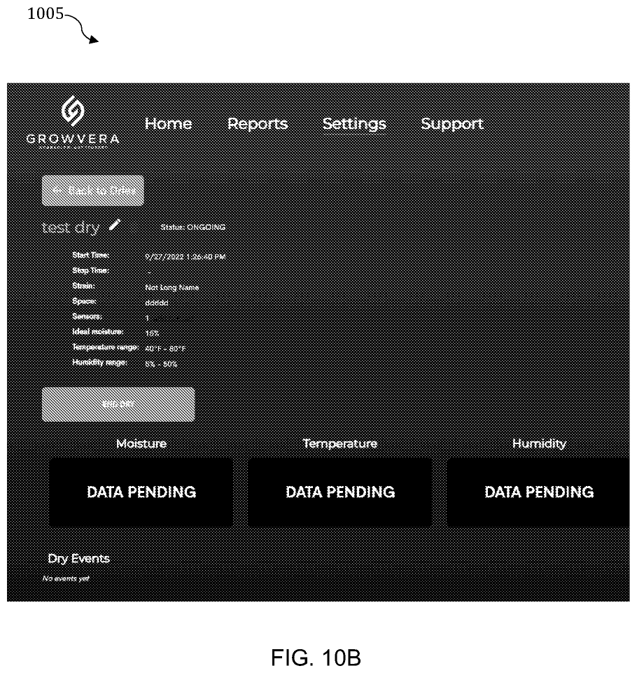

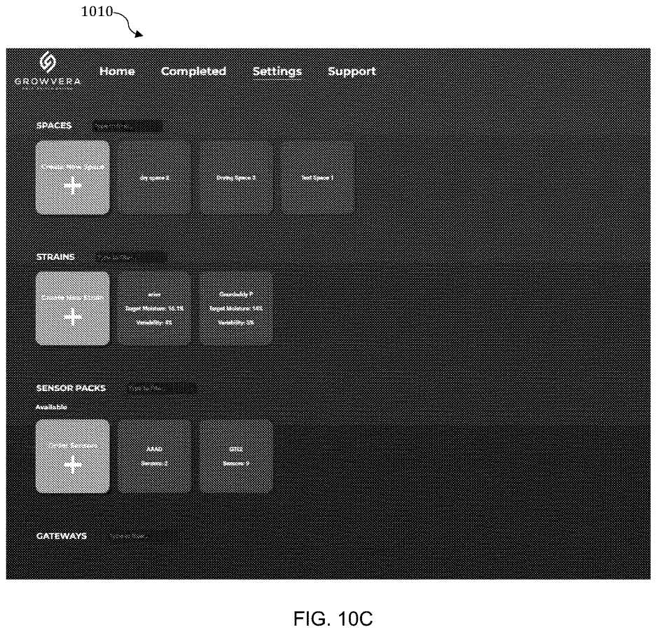

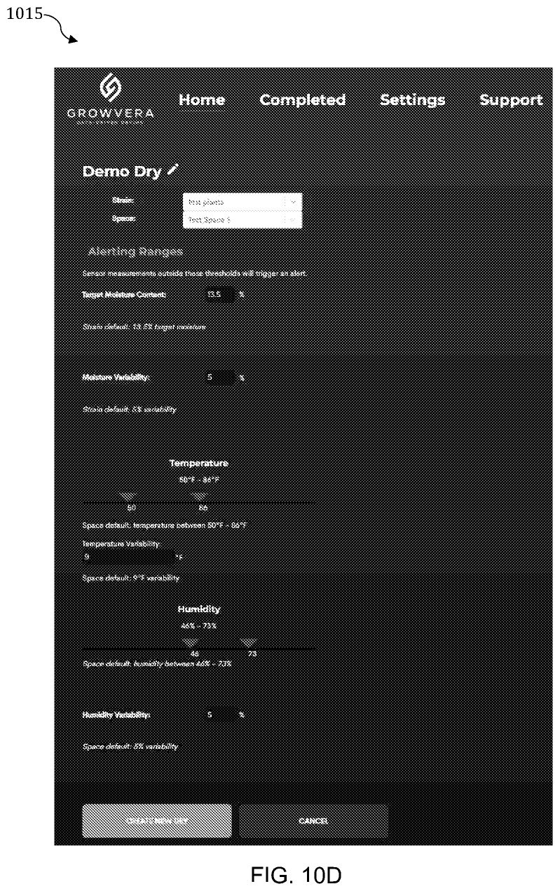

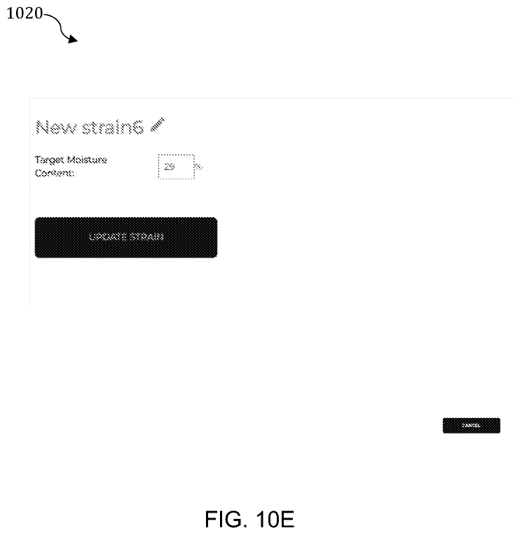

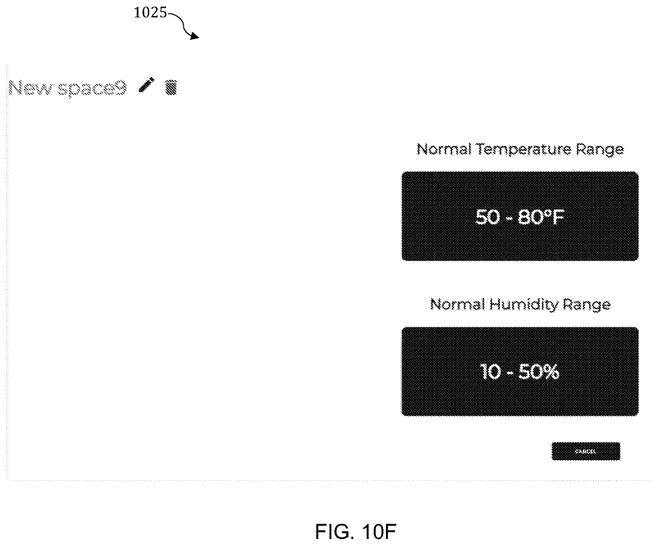

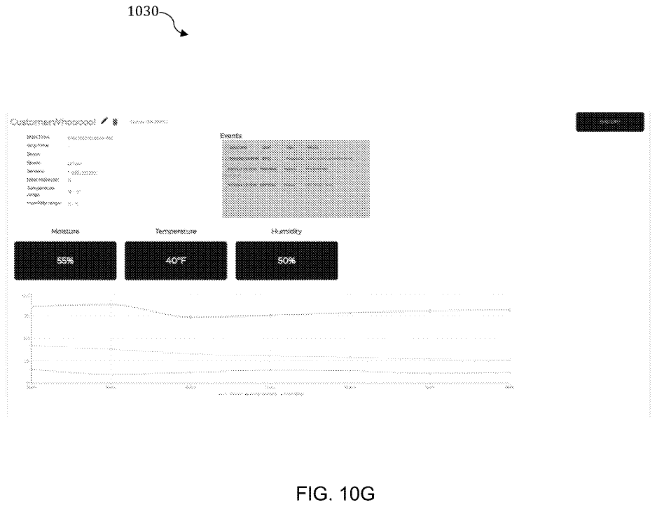

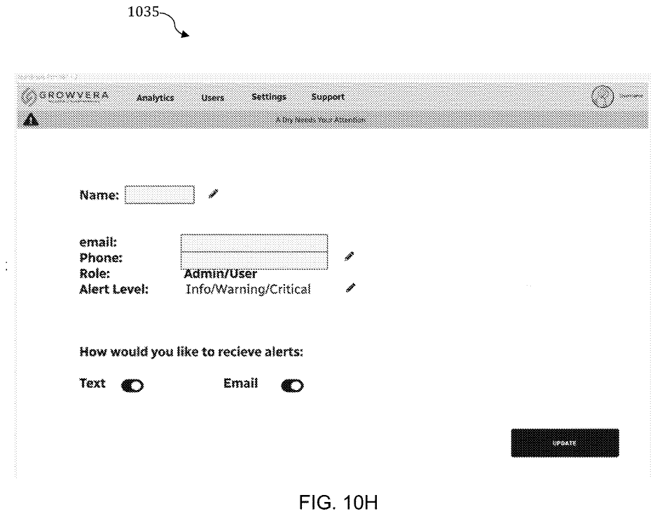

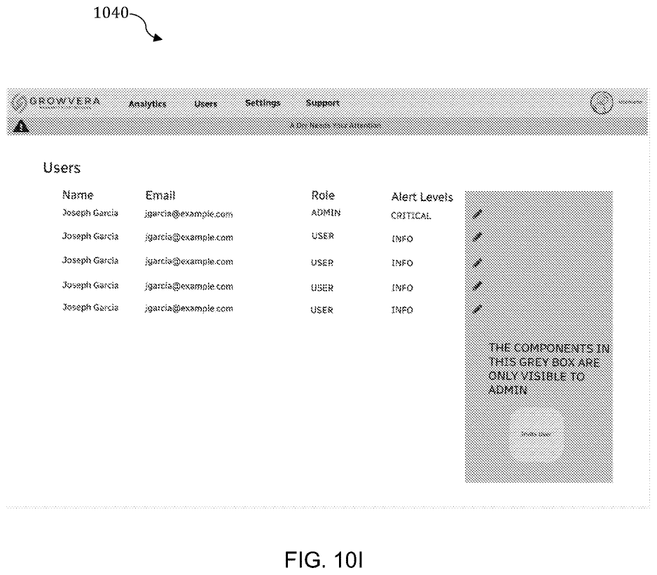

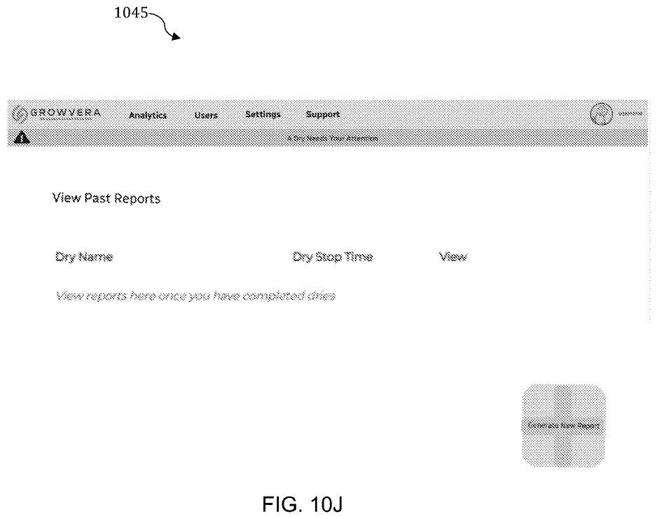

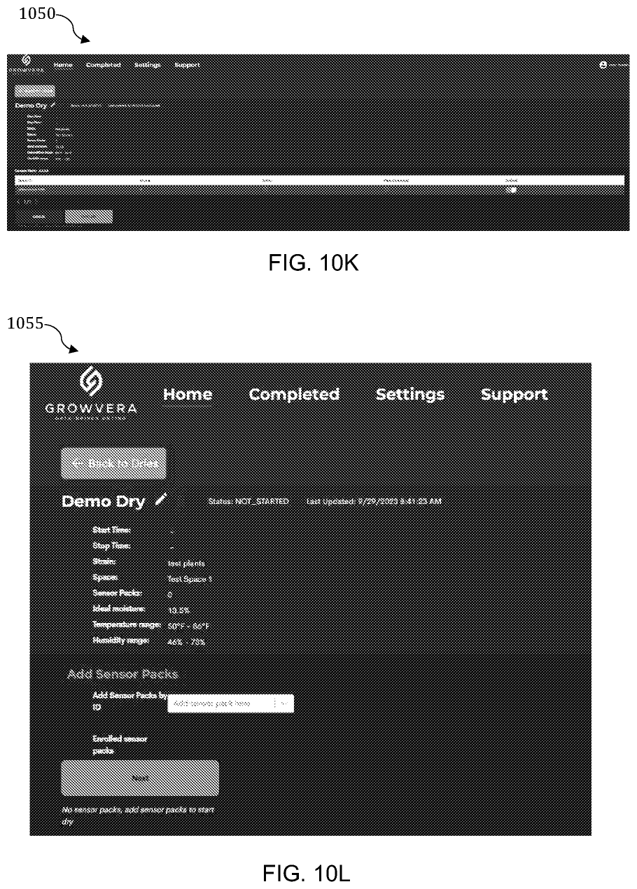

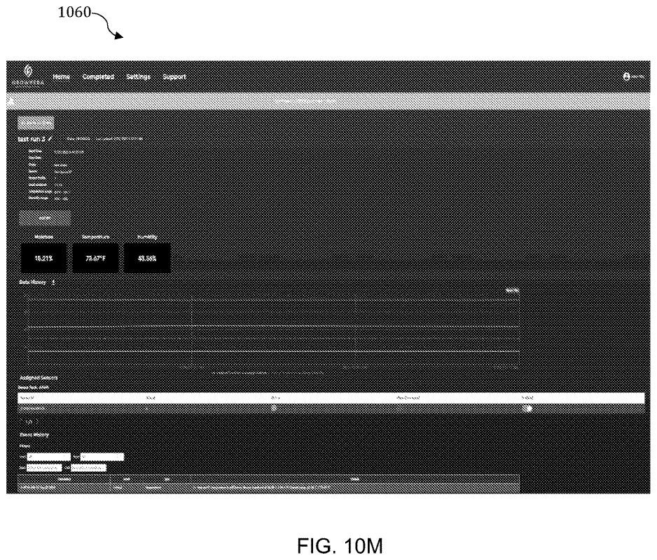

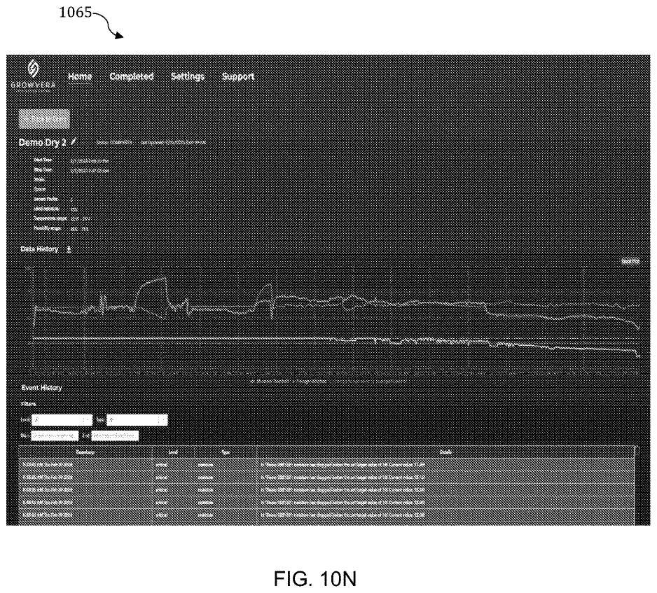

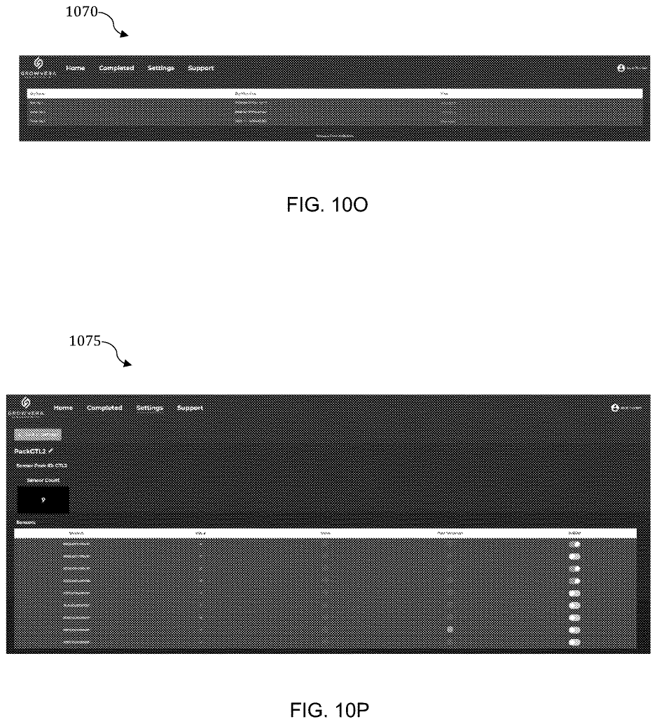

FIGS. 10A-10J illustrate exemplary user interfaces associated with the client application 120. In certain embodiments, multiple user interfaces can be provided for local and remote system control, monitoring, and reporting of data analytics including web-based applications, mobile applications, local operator control consoles, and centralized display dashboards with key operational metrics such as moisture, yield, and product quality. The collection of metrics can include those metrics required for regulatory compliance and asset tracking.

FIG. 10A illustrates an exemplary home screen view 1000 of the client application 120. This screen provides a status of ongoing and completed drying processes. Additional information can be accessed by selecting and clicking on the various buttons.

FIG. 10B illustrates a selected drying screen view 1005 of the client application 120, where specific data about a particular drying session is provided. The client application 120 can provide details regarding moisture, temperature, humidity, as well as timing sensors in use, and strain data. The screen view 1005 can include a button to end the drying session if desired.

FIG. 10C illustrates an exemplary settings screen view 1010 of the client application 120. In the settings screen view, the client application can be used to manage plant strains, sensors, drying spaces, and other resources affiliated with the drying process.

FIG. 10D illustrates an exemplary create new dry screen view 1015 of the client application 120. This screen view allows for the instantiation of a new drying process. The plant strain and space for the dry can be defined, and sensors can be assigned to the drying process. Additionally, drying process parameters, desired moisture content, and alert thresholds for the new drying session can be set using the create new dry screen 1015.

FIG. 10E illustrates an exemplary strain screen view 1020 of the client application 120. The view is configured to set a plant strain name and a target moisture content on which future dries of this plant strain can be evaluated against.

FIG. 10F illustrates an exemplary drying space screen view 1025 of the client application 120. This view is configured to set space name, normal temperature range for the space, and normal humidity range for the space. These ranges can be used for analytics, and to set alert thresholds for drying processes in the space.

FIG. 10G illustrates an exemplary individual dry process screen view 1030 of the client application 120. This view is configured to provide details pertaining to a particular drying process including, but not limited to, current and historical temperature, humidity, moisture levels, events, start and stop times, space, plant strain, assigned sensors, and dry configuration.

FIG. 10H illustrates an exemplary edit profile screen view 1035 of the client application 120. This view is configured to set user information, such as username, phone number, email, customer affiliation, and role. Alert level management is provided on the edit profile screen view 1035, along with toggles to select the mode of alerts, such as email or text message.

FIG. 10I illustrates an exemplary user management screen view 1040 of the client application 120. This view is configured to provide user information such as members within an organization and authority level. The user management screen view 1040 can be used to invite users to an organization, modify user parameters and permissions, set user roles, and set alert levels.

FIG. 10J illustrates an exemplary analytics screen view 1045 of the client application 120. This view is configured to display current or historic analytics reports, interact with such reports as well as to generate new analysis reports.

FIG. 10K illustrates an exemplary pending dry configuration screen view 1050 of the client application 120. This view is configured to display start and stop times, plant strain, space, sensor packs in use, ideal moisture, temperature range, and humidity range. This view allows these parameters to be configured.

FIG. 10L illustrates an exemplary pending dry screen view 1055 of the client application 120. This view displays start and stop times, plant strain, space, sensor packs in use, ideal moisture, temperature range, and humidity range for a pending dry process.

FIG. 10M illustrates an exemplary ongoing dry screen view 1060 of the client application 120. This view displays start and stop times, plant strain, space, sensor packs in use, ideal moisture, temperature range, and humidity range for an ongoing dry process. The view also illustrates current moisture, temperature, and humidity and provides historic data, assigned sensors, and alerts for an ongoing dry.

FIG. 10N illustrates an exemplary completed dry screen view 1065 of the client application 120. This view displays start and stop times, plant strain, space, sensor packs in use, ideal moisture, temperature range, and humidity range for a completed dry process. The view also illustrates historic data, assigned sensors, and alerts for a completed dry process.

FIG. 10O illustrates an exemplary completed dry list screen view 1070 of the client application 120. This view displays a list of completed dry processes.

FIG. 10P illustrates an exemplary completed sensor pack screen view 1075 of the client application 120. This view displays deployed sensors, along with an alias for the sensor, its status, whether it is plant connected, and whether it is enabled.

In other embodiments, the user interface 915 can provide a complete view of the plant life cycle from cloning, rooting, growing, flowering, drying, curing, and packing for sale, operational resource planning and production management, analytics to inform changes to drying process and facilities to optimize drying outcomes, and artificial intelligence driven algorithms to analyze and optimize performance using data from the entire customer base.

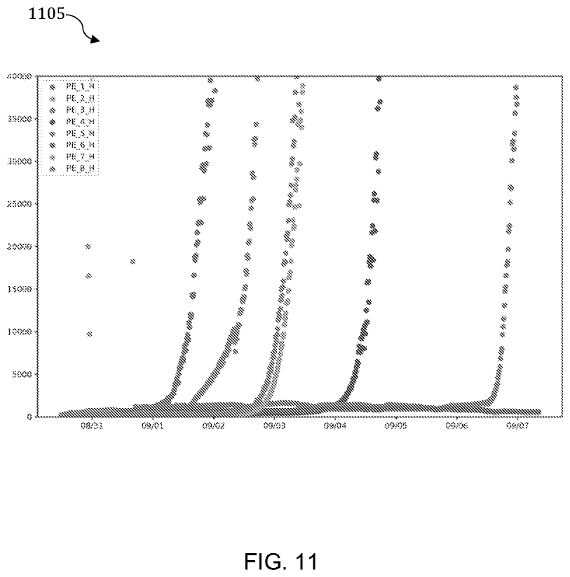

The disclosed systems and methods are unique as compared with other known systems and solutions in that they provides continuous data. FIG. 11 provides a chart 1105 illustrating moisture levels from multiple sources within a drying process in accordance with data collected from sensors as disclosed herein. The chart 1105 provides insights into drying chamber optimization, moisture optimization, and drying operations management that are unobtainable to a system that provides only single point moisture measurements. Exemplary data in chart 1105 shows plant material dryness on multiple plants measured over time.

Similarly, the embodiments disclosed herein are unique when compared with other known solutions in that they provide visibility into drying operations without any personnel present, allowing for a remote “hands-off” approach in which personnel are only present as required. Further, it provides a unified platform where drying resources, data, and activities may be coordinated with ease.

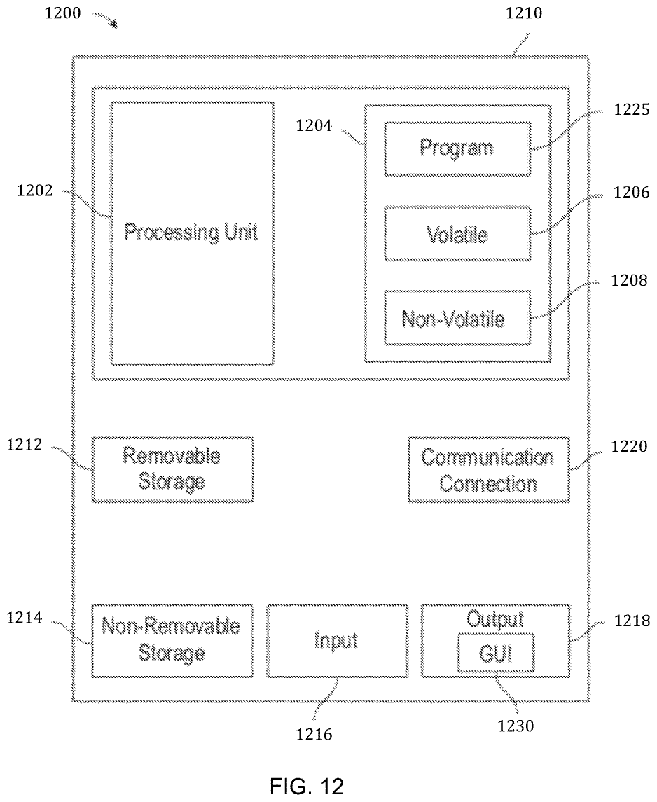

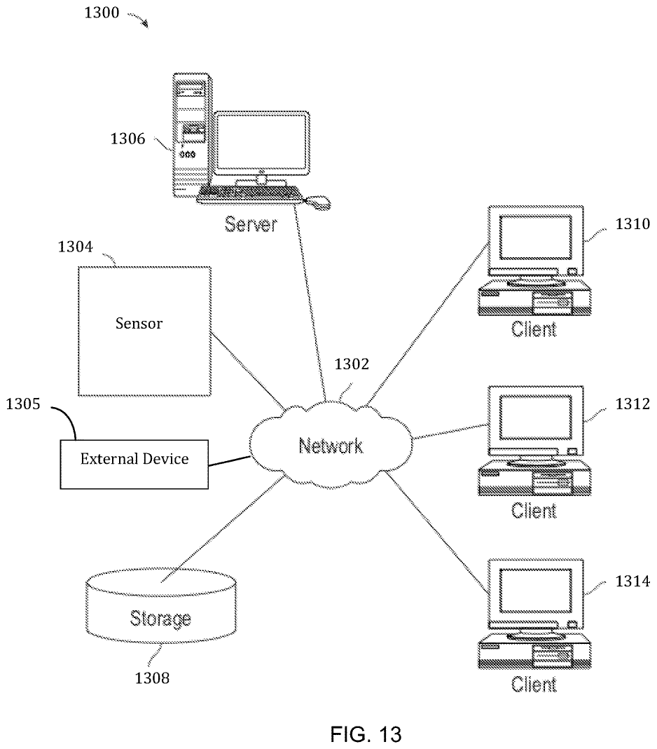

FIGS. 12-14 are provided as exemplary diagrams of data-processing environments in which embodiments of the present invention may be implemented. It should be appreciated that FIGS. 12-14 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 1200 that executes programming for implementing parts of the methods and systems disclosed herein is shown in FIG. 12. A computing device in the form of a computer 1210 configured to interface with sensors, peripheral devices, and other elements disclosed herein may include one or more processing units 1202, memory 1204, removable storage 1212, and non-removable storage 1214. Memory 1204 may include volatile memory 1206 and non-volatile memory 1208. Computer 1210 may include or have access to a computing environment that includes a variety of transitory and non-transitory computer-readable media such as volatile memory 1206 and non-volatile memory 1208, removable storage 1212 and non-removable storage 1214. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

Computer 1210 may include or have access to a computing environment that includes input 1216, output 1218, and a communication connection 1220. The computer may operate in a networked environment using a communication connection 1220 to connect to one or more remote computers, remote sensors, detection devices, hand-held devices, multi-function devices (MFDs), mobile devices, tablet devices, mobile phones, Smartphones, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 13 below.

Output 1218 is most commonly provided as a computer monitor, but may include any output device. Output 1218 and/or input 1216 may include a data collection apparatus associated with computer system 1200. In addition, input 1216, which commonly includes a computer keyboard and/or pointing device such as a computer mouse, computer track pad, or the like, allows a user to select and instruct computer system 1200. A user interface can be provided using output 1218 and input 1216. Output 1218 may function as a display for displaying data and information for a user, and for interactively displaying a graphical user interface (GUI) 1230.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 1216 such as, for example, a pointing device such as a mouse and/or with a keyboard. A particular item can function in the same manner to the user in all applications because the GUI provides standard software routines (e.g., module 1225) to handle these elements and report the user's actions.

Computer-readable instructions, for example, program module or node 1225, which can be representative of other modules or nodes described herein, are stored on a computer-readable medium and are executable by the processing unit 1202 of computer 1210. Program module or node 1225 may include a computer application. A hard drive, CD-ROM, RAM, Flash Memory, and a USB drive are just some examples of articles including a computer-readable medium.

FIG. 13 depicts a graphical representation of a network of data-processing systems 1300 in which aspects of the present invention may be implemented. Network data-processing system 1300 is a network of computers or other such devices such as mobile phones, smartphones, sensors, detection devices, and the like in which embodiments of the present invention may be implemented. Note that the system 1300 can be implemented in the context of a software module such as program module 1225. The system 1300 includes a network 1302 in communication with one or more clients 1310, 1312, and 1314, and external device 1305. Network 1302 may also be in communication with one or more external devices, including but not limited to RFID and/or GPS enabled devices or sensors 1304, servers 1306, and storage 1308. Network 1302 is a medium that can be used to provide communications links between various devices and computers connected together within a networked data processing system such as computer system 1200. Network 1302 may include connections such as wired communication links, wireless communication links of various types, fiber optic cables, quantum, or quantum encryption, or quantum teleportation networks, etc. Network 1302 can communicate with one or more servers 1306, one or more external devices such as RFID and/or GPS enabled device 1304, and a memory storage unit such as, for example, memory or database 1308. It should be understood that external device 1304 may be embodied as a mobile device, cell phone, tablet device, monitoring device, detector device, sensor microcontroller, controller, receiver, transceiver, or other such device.

In the depicted example, external device 1304, server 1306, and clients 1310, 1312, and 1314 connect to network 1302 along with storage unit 1308. Clients 1310, 1312, and 1314 may be, for example, personal computers or network computers, handheld devices, mobile devices, tablet devices, smartphones, personal digital assistants, microcontrollers, recording devices, MFDs, etc. Computer system 1200 depicted in FIG. 12 can be, for example, a client such as client 1310 and/or 1312.

Computer system 1200 can also be implemented as a server such as server 1306, depending upon design considerations. In the depicted example, server 1306 provides data such as boot files, operating system images, applications, and application updates to clients 1310, 1312, and/or 1314. Clients 1310, 1312, and 1314 and external device 1304 are clients to server 1306 in this example. Network data-processing system 1300 may include additional servers, clients, and other devices not shown. Specifically, clients may connect to any member of a network of servers, which provide equivalent content.

In the depicted example, network data-processing system 1300 is the Internet with network 1302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 1300 may also be implemented as a number of different types of networks such as, for example, an intranet, a local area network (LAN), or a wide area network (WAN). FIGS. 12 and 13 are intended as examples and not as architectural limitations for different embodiments of the present invention.

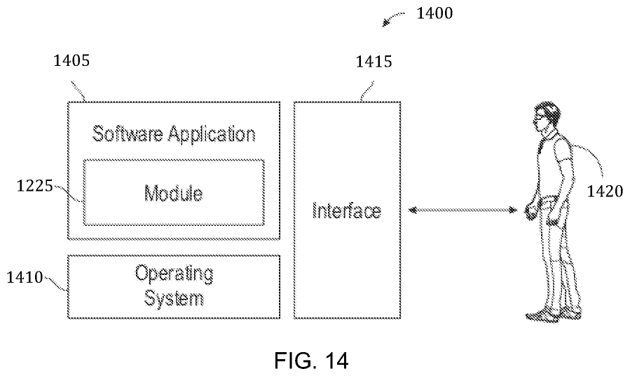

FIG. 14 illustrates a software system 1400, which may be employed for directing the operation of the data-processing systems such as computer system 1200 depicted in FIG. 12. Software application 1405, may be stored in memory 1204, on removable storage 1212, or on non-removable storage 1214 shown in FIG. 12, and generally includes and/or is associated with a kernel or operating system 1410 and a shell or interface 1415. One or more application programs, such as module(s) or node(s) 1225, may be “loaded” (i.e., transferred from removable storage 1214 into the memory 1204) for execution by the data-processing system 1200. The data-processing system 1200 can receive user commands and data through user interface 1415, which can include input 1216 and output 1218, accessible by a user 1420. These inputs may then be acted upon by the computer system 1200 in accordance with instructions from operating system 1410 and/or software application 1405 and any software module(s) 1225 thereof.

Generally, program modules (e.g., module 1225) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices, multi-processor systems, printers, copiers, fax machines, multi-function devices, data networks, microprocessor-based or programmable consumer electronics, networked personal computers, minicomputers, mainframe computers, servers, medical equipment, medical devices, and the like.

Note that the term module or node as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module), and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 1415 (e.g., a graphical user interface 1230) can serve to display results, whereupon a user 1420 may supply additional inputs or terminate a particular session. In some embodiments, operating system 1410 and GUI 1230 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 1410 and interface 1415. The software application 1405 can include, for example, module(s) 1225, which can include instructions for carrying out steps or logical operations such as those shown and described herein.

The following description is presented with respect to embodiments of the present invention, which can be embodied in the context of, or require the use of a data-processing system such as computer system 1200, in conjunction with program module 1225, and data-processing system 1300 and network 1302 depicted in FIGS. 12-3. The present invention, however, is not limited to any particular application or any particular environment. Instead, those skilled in the art will find that the systems and methods of the present invention may be advantageously applied to a variety of system and application software including database management systems, word processors, and the like. Moreover, the present invention may be embodied on a variety of different platforms including Windows, Macintosh, UNIX, LINUX, Android, Arduino and the like. Therefore, the descriptions of the exemplary embodiments, which follow, are for purposes of illustration and not considered a limitation.

Based on the foregoing, it can be appreciated that a number of embodiments, preferred and alternative, are disclosed herein. In an embodiment, a system comprises at least one sensor; and a computer system, the computer system further comprising at least one processor; and a computer-usable medium embodying computer program code, the computer-usable medium capable of communicating with the at least one processor, the computer program code comprising instructions executable by the at least one processor and comprising a server application configured for: collecting data from the at least one sensor attached to a plant; analyzing the data to characterize a drying process associated with the plant; and at least one client application configured for: providing the analyzed data associated with the drying process associated with the plant on a user interface.

In an embodiment, the at least one sensor is capable of measuring at least one of moisture, temperature, and humidity.

In an embodiment, analyzing the data to characterize the moisture content of the plant further comprises determining whether drying process conditions require intervention and sending an alert when the drying process conditions require intervention.

In an embodiment, the server application is further configured for characterizing the spatial uniformity and quality of a drying chamber according to the data from the at least one sensor. In an embodiment, the client application is further configured for providing control commands to environmental hardware. In an embodiment, the environmental hardware comprises at least one of HVAC equipment, humidifiers, and dehumidifiers.

In an embodiment, the system further comprises at least one off-plant sensor configured to measure at least one of humidity, temperature, pressure, light level, air flow, and water quality.

In an embodiment, the server application is further configured for storing the data to characterize a drying process associated with the plant in a database organized according to the order of each drying process.

In an embodiment, the server application is configured for generating predictive analytics during the drying process according to the analyzed data and historical data. In an embodiment, the predictive analytics comprise at least one of estimation of dry-process completion using data from previous dry processes, identification of adverse drying process conditions, recommended drying operational changes, and management and restriction of drying process operations.

In an embodiment, the at least one sensor comprises a plurality of sensors wherein each sensor in the plurality of sensors is disposed on a different plant.

In an embodiment, a method for characterizing a drying process comprises connecting at least one sensor to a plant, collecting data from the at least one sensor at a server application, the server application being run on a computer system, the computer system further comprising: at least one processor; and a computer-usable medium embodying computer program code, the computer-usable medium capable of communicating with the at least one processor, the computer program code comprising instructions executable by the at least one processor and comprising: analyzing the data from the at least one sensor in order to characterize a drying process associated with the plant; and providing the analyzed data associated with the drying process associated with the plant with a client application.

In an embodiment of the method, analyzing the data to characterize the moisture content of the plant further comprises determining whether drying process conditions require intervention and sending an alert when the drying process conditions require intervention.

In an embodiment, the method further comprises characterizing the spatial uniformity and quality of a drying chamber according to the data from the at least one sensor.

In an embodiment, the method further comprises providing control commands to environmental hardware in order to adjust ambient conditions associated with the drying process.

In an embodiment, the method comprises measuring, with at least one sensor, at least one of moisture, temperature, and humidity. In an embodiment the method comprises measuring, with at least one off-plant sensor, at least one of humidity, temperature, pressure, light level, air flow, and water quality.

In an embodiment, the method further comprises generating predictive analytics during the drying process according to the analyzed data and historical data. In an embodiment, the predictive analytics comprise at least one of estimation of dry-process completion using data from previous dry processes, identification of adverse drying process conditions, recommended drying operational changes, and management and restriction of drying process operations.

In another embodiment, a system comprises at least one sensor, a computer system, the computer system further comprising: at least one processor; and a computer-usable medium embodying computer program code, the computer-usable medium capable of communicating with the at least one processor, the computer program code comprising instructions executable by the at least one processor and comprising: a server application configured for: collecting data from the at least one sensor attached to a plant; analyzing the data to characterize a drying process associated with the plant; sending an alert when conditions associated with the drying process require intervention; and controlling environmental hardware in the environment associated with the drying process; a second computer system, the second computer system further comprising: at least one processor; a graphical user interface; and a computer-usable medium embodying computer program code, the computer-usable medium capable of communicating with the at least one processor, the computer program code comprising instructions executable by the at least one processor and comprising: at least one client application configured for: providing the analyzed data associated with the drying process associated with the plant on a user interface.

In an embodiment, the at least one sensor comprises an upper housing, a printed circuit board housed in the upper housing, a lower housing, an axel pin connecting the upper housing and lower housing, and at least one probe configured to be inserted into a plant.

In an embodiment, the printed circuit board further comprises a probe subsystem, a power and battery management subsystem, a processing subsystem, a user interface subsystem, a radio subsystem, and an analog front end subsystem.

It should be appreciated that variations of the above-disclosed and other features and functions, or alternatives thereof, may be desirably combined into many other different systems or applications. It should be understood that various presently unforeseen or unanticipated alternatives, modifications, variations, or improvements therein may be subsequently made by those skilled in the art which are also intended to be encompassed by the following claims.

What is claimed is:

1. A system comprising:
at least one sensor; and
a computer system, the computer system further comprising:
at least one processor; and
a computer-usable medium embodying computer program code, the computer-usable medium capable of communicating with the at least one processor, the computer program code comprising instructions executable by the at least one processor and comprising:
a server application configured for:
collecting data from the at least one sensor attached to a plant;
analyzing the data to characterize a drying process associated with the plant; and
at least one client application configured for:
providing the analyzed data associated with the drying process associated with the plant on a user interface.

2. The system of claim 1 wherein the at least one sensor is capable of measuring at least one of:
moisture;
temperature; and
humidity 3. The system of claim 1 wherein analyzing the data to characterize the drying process further comprises:
determining whether drying process conditions require intervention; and
sending an alert when the drying process conditions require intervention.

4. The system of claim 1 wherein the server application is further configured for:
characterizing spatial uniformity and quality of a drying chamber according to the data from the at least one sensor.

5. The system of claim 1 wherein the at least one client application is further configured for:
providing control commands to environmental hardware.

6. The system of claim 5 wherein the environmental hardware comprises at least one of:
HVAC equipment;
humidifiers; and
dehumidifiers.

7. The system of claim 1 further comprising:
at least one off-plant sensor configured to measure at least one of:
humidity;
temperature;
pressure;
light level;
air flow; and
water quality.

8. The system of claim 1 wherein the server application is further configured for:
storing the data to characterize a drying process associated with the plant in a database organized according to an order of each drying process.

9. The system of claim 1 wherein the server application is configured for:
generating predictive analytics during the drying process according to the analyzed data and historical data.

10. The system of claim 9 wherein the predictive analytics comprise at least one of:
estimation of dry-process completion using data from previous dry processes;
identification of adverse drying process conditions;
recommended drying operational changes; and
management and restriction of drying process operations.

11. The system of claim 1 wherein the at least one sensor comprises a plurality of sensors wherein each sensor in the plurality of sensors is disposed on a different plant.

12. A method for characterizing a drying process comprising:
connecting at least one sensor to a plant;
collecting data from the at least one sensor at a server application, the server application being run on a computer system, the computer system further comprising: at least one processor; and a computer-usable medium embodying computer program code, the computer-usable medium capable of communicating with the at least one processor, the computer program code comprising instructions executable by the at least one processor and comprising:
analyzing the data from the at least one sensor in order to characterize a drying process associated with the plant; and
providing the analyzed data associated with the drying process associated with the plant with a client application.

13. The method of claim 12 wherein analyzing the data to characterize the drying process further comprises:
determining whether drying process conditions require intervention; and
sending an alert when the drying process conditions require intervention.

14. The method of claim 12 further comprising:
characterizing spatial uniformity and quality of a drying chamber according to the data from the at least one sensor.

15. The method of claim 12 further comprising:
providing control commands to environmental hardware in order to adjust ambient conditions associated with the drying process.

16. The method of claim 12 further comprising:
measuring, with at least one sensor, at least one of:
moisture;
temperature; and
humidity.

17. The method of claim 12 further comprising:
measuring, with at least one off-plant sensor, at least one of:
humidity;
temperature;
pressure;
light level;
air flow; and
water quality.

18. The method of claim 12 further comprising:
generating predictive analytics during the drying process according to the analyzed data and historical data.

19. The method of claim 18 wherein the predictive analytics comprise at least one of:
estimation of dry-process completion using data from previous dry processes;
identification of adverse drying process conditions;
recommended drying operational changes; and
management and restriction of drying process operations.

20. A system comprising:
at least one sensor;
a computer system, the computer system further comprising:
at least one processor; and
a computer-usable medium embodying computer program code, the computer-usable medium capable of communicating with the at least one processor, the computer program code comprising instructions executable by the at least one processor and comprising:
a server application configured for:
collecting data from the at least one sensor attached to a plant;
analyzing the data to characterize a drying process associated with the plant;
sending an alert when conditions associated with the drying process require intervention.
